(19) United States
(12) Patent Application Publication
(10) Pub. No.: US 2026/0211703 A1
(43) Pub. Date: Jul. 23, 2026

(54) CNI PLUGIN FOR FORMING SATELLITE SERVICE CHAINS AT COMPUTE INFRASTRUCTURE

(71) Applicant: Kratos Integral Holdings LLC, San Diego, CA (US)

(72) Inventors: Doug Duerner, Rocklin, CA (US); Donald Robert Wallom, Lincoln, CA (US)

(21) Appl. No.: 19/034,910

(22) Filed: Jan. 23, 2025

(51) Int. Cl. G06F 9/445

(52) U.S. Cl. CPC G06F 9/44526

(57) ABSTRACT

Described herein are systems, methods, and other techniques for forming a satellite service chain within a compute infrastructure or cluster. A method includes deploying a first pod implementing a first VNF on a first compute node based on a first configuration file and a second pod implementing a second VNF on a second compute node based on a second configuration file. The first configuration file specifies that a subsequent pod for the first pod is the second pod and the second configuration file specifies that a previous pod for the second pod is the first pod. The method further includes running a first CNI plugin on the first compute node to connect the first pod to a designated interface of the first compute node, and running a second CNI plugin on the second compute node to connect the second pod to a designated interface of the second compute node.

### BACKGROUND OF THE INVENTION

Distributed systems, such as those used in cloud computing architectures, can enhance the processing capabilities of satellite communication systems by leveraging robust infrastructure and scalable resources. In a satellite communication system, a significant amount of data is transmitted from satellites orbiting the Earth to ground stations. Traditionally, this process requires extensive on-ground infrastructure for data processing and storage, which can be costly and inflexible. By integrating cloud computing, these high-performance workloads can be offloaded to cloud servers, where they benefit from advanced processing power and elastic storage capabilities. This integration enables real-time data analysis and processing for applications such as communications, weather forecasting, and telemetry analysis, without the need for extensive physical infrastructure at the ground station. Moreover, cloud computing systems facilitate improved data sharing between different entities and regions by providing a centralized platform accessible from anywhere in the world.

### SUMMARY OF THE INVENTION

A summary of the various embodiments of the invention is provided below as a list of examples. As used below, any reference to a series of examples is to be understood as a reference to each of those examples disjunctively (e.g., “Examples 1-4” is to be understood as “Examples 1, 2, 3, or 4”).
Example 1 is a method of forming a satellite service chain at a compute infrastructure having a set of compute nodes, the method comprising: deploying a first pod on a first compute node of the compute infrastructure based on a first configuration file, the first pod implementing a first virtual network function (VNF), wherein the first configuration file specifies a previous pod and a subsequent pod for the first pod in the satellite service chain; deploying a second pod on a second compute node of the compute infrastructure based on a second configuration file, the second pod implementing a second VNF, wherein the second configuration file specifies a previous pod and a subsequent pod for the second pod in the satellite service chain, wherein the subsequent pod for the first pod is set to the second pod, and wherein the previous pod for the second pod is set to the first pod; running a first container network interface (CNI) plugin on the first compute node, wherein the first CNI plugin is configured to connect the first pod to a first interface of a set of interfaces of the first compute node in accordance with the first configuration file; and running a second CNI plugin on the second compute node, wherein the second CNI plugin is configured to connect the second pod to a second interface of a set of interfaces of the second compute node in accordance with the second configuration file, wherein the satellite service chain is formed by connecting the first and second pods to the first and second interfaces in accordance with the first and second configuration files.
Example 2 is the method of example(s) 1, further comprising: deploying a third pod on the first compute node based on a third configuration file, the third pod implementing a third VNF, wherein the third configuration file specifies a previous pod and a subsequent pod for the third pod in the satellite service chain, wherein the subsequent pod for the third pod is set to the first pod, and wherein the previous pod for the first pod is set to the third pod; wherein the first CNI plugin is configured to connect the third pod to the first interface of the set of interfaces of the first compute node in accordance with the third configuration file.
Example 3 is the method of example(s) 2, further comprising: deploying a fourth pod on the second compute node based on a fourth configuration file, the fourth pod implementing a fourth VNF, wherein the fourth configuration file specifies a previous pod and a subsequent pod for the fourth pod in the satellite service chain, wherein the subsequent pod for the second pod is set to the fourth pod, and wherein the previous pod for the fourth pod is set to the second pod; wherein the second CNI plugin is configured to connect the fourth pod to the second interface of the set of interfaces of the second compute node in accordance with the fourth configuration file.
Example 4 is the method of example(s) 1-3, further comprising: adding a new pod to the satellite service chain by: deploying the new pod on the first compute node or the second compute node based on a configuration file for the new pod; and modifying the first configuration file using the first CNI plugin or the second configuration file using the second CNI plugin to set at least one of the previous pod for the first pod, the subsequent pod for the first pod, the previous pod for the second pod, the subsequent pod for the second pod to the new pod.
Example 5 is the method of example(s) 1-4, wherein the first CNI plugin is further configured to assign a first internet protocol (IP) address to the first pod, and wherein the second CNI plugin is further configured to assign a second IP address to the second pod, and so on for all subsequent pods that form the satellite service chain.
Example 6 is the method of example(s) 1-5, wherein each of the first VNF and the second VNF is a virtual receiver, a virtual transmitter, or a combiner, among other possibilities.
Example 7 is the method of example(s) 1-6, wherein the compute infrastructure is a cluster consisting of a set of servers including the set of compute nodes.
Example 8 is a non-transitory computer-readable medium comprising instructions that, when executed by one or more processors, cause the one or more processors to perform operations for forming a satellite service chain at a compute infrastructure having a set of compute nodes, the operations comprising: deploying a first pod on a first compute node of the compute infrastructure based on a first configuration file, the first pod implementing a first virtual network function (VNF), wherein the first configuration file specifies a previous pod and a subsequent pod for the first pod in the satellite service chain; deploying a second pod on a second compute node of the compute infrastructure based on a second configuration file, the second pod implementing a second VNF, wherein the second configuration file specifies a previous pod and a subsequent pod for the second pod in the satellite service chain, wherein the subsequent pod for the first pod is set to the second pod, and wherein the previous pod for the second pod is set to the first pod; running a first container network interface (CNI) plugin on the first compute node, wherein the first CNI plugin is configured to connect the first pod to a first interface of a set of interfaces of the first compute node in accordance with the first configuration file; and running a second CNI plugin on the second compute node, wherein the second CNI plugin is configured to connect the second pod to a second interface of a set of interfaces of the second compute node in accordance with the second configuration file, wherein the satellite service chain is formed by connecting the first and second pods to the first and second interfaces in accordance with the first and second configuration files.
Example 9 is the non-transitory computer-readable medium of example(s) 8, wherein the operations further comprise: deploying a third pod on the first compute node based on a third configuration file, the third pod implementing a third VNF, wherein the third configuration file specifies a previous pod and a subsequent pod for the third pod in the satellite service chain, wherein the subsequent pod for the third pod is set to the first pod, and wherein the previous pod for the first pod is set to the third pod; wherein the first CNI plugin is configured to connect the third pod to the first interface of the set of interfaces of the first compute node in accordance with the third configuration file.
Example 10 is the non-transitory computer-readable medium of example(s) 9, wherein the operations further comprise: deploying a fourth pod on the second compute node based on a fourth configuration file, the fourth pod implementing a fourth VNF, wherein the fourth configuration file specifies a previous pod and a subsequent pod for the fourth pod in the satellite service chain, wherein the subsequent pod for the second pod is set to the fourth pod, and wherein the previous pod for the fourth pod is set to the second pod; wherein the second CNI plugin is configured to connect the fourth pod to the second interface of the set of interfaces of the second compute node in accordance with the fourth configuration file.
Example 11 is the non-transitory computer-readable medium of example(s) 8-10, wherein the operations further comprise: adding a new pod to the satellite service chain by: deploying the new pod on the first compute node or the second compute node based on a configuration file for the new pod; and modifying the first configuration file using the first CNI plugin or the second configuration file using the second CNI plugin to set at least one of the previous pod for the first pod, the subsequent pod for the first pod, the previous pod for the second pod, the subsequent pod for the second pod to the new pod.
Example 12 is the non-transitory computer-readable medium of example(s) 8-11, wherein the first CNI plugin is further configured to assign a first internet protocol (IP) address to the first pod, and wherein the second CNI plugin is further configured to assign a second IP address to the second pod, and so on for all subsequent pods that form the satellite service chain.
Example 13 is the non-transitory computer-readable medium of example(s) 8-12, wherein each of the first VNF and the second VNF is a virtual receiver, a virtual transmitter, or a combiner, among other possibilities.
Example 14 is the non-transitory computer-readable medium of example(s) 8-13, wherein the compute infrastructure is a cluster consisting of a set of servers including the set of compute nodes.
Example 15 is a system comprising: one or more processors; and a computer-readable medium comprising instructions that, when executed by the one or more processors, cause the one or more processors to perform operations for forming a satellite service chain at a compute infrastructure having a set of compute nodes, the operations comprising: deploying a first pod on a first compute node of the compute infrastructure based on a first configuration file, the first pod implementing a first virtual network function (VNF), wherein the first configuration file specifies a previous pod and a subsequent pod for the first pod in the satellite service chain; deploying a second pod on a second compute node of the compute infrastructure based on a second configuration file, the second pod implementing a second VNF, wherein the second configuration file specifies a previous pod and a subsequent pod for the second pod in the satellite service chain, wherein the subsequent pod for the first pod is set to the second pod, and wherein the previous pod for the second pod is set to the first pod; running a first container network interface (CNI) plugin on the first compute node, wherein the first CNI plugin is configured to connect the first pod to a first interface of a set of interfaces of the first compute node in accordance with the first configuration file; and running a second CNI plugin on the second compute node, wherein the second CNI plugin is configured to connect the second pod to a second interface of a set of interfaces of the second compute node in accordance with the second configuration file, wherein the satellite service chain is formed by connecting the first and second pods to the first and second interfaces in accordance with the first and second configuration files.
Example 16 is the system of example(s) 15, wherein the operations further comprise: deploying a third pod on the first compute node based on a third configuration file, the third pod implementing a third VNF, wherein the third configuration file specifies a previous pod and a subsequent pod for the third pod in the satellite service chain, wherein the subsequent pod for the third pod is set to the first pod, and wherein the previous pod for the first pod is set to the third pod; wherein the first CNI plugin is configured to connect the third pod to the first interface of the set of interfaces of the first compute node in accordance with the third configuration file.
Example 17 is the system of example(s) 16, wherein the operations further comprise: deploying a fourth pod on the second compute node based on a fourth configuration file, the fourth pod implementing a fourth VNF, wherein the fourth configuration file specifies a previous pod and a subsequent pod for the fourth pod in the satellite service chain, wherein the subsequent pod for the second pod is set to the fourth pod, and wherein the previous pod for the fourth pod is set to the second pod; wherein the second CNI plugin is configured to connect the fourth pod to the second interface of the set of interfaces of the second compute node in accordance with the fourth configuration file.
Example 18 is the system of example(s) 15-17, wherein the operations further comprise: adding a new pod to the satellite service chain by: deploying the new pod on the first compute node or the second compute node based on a configuration file for the new pod; and modifying the first configuration file using the first CNI plugin or the second configuration file using the second CNI plugin to set at least one of the previous pod for the first pod, the subsequent pod for the first pod, the previous pod for the second pod, the subsequent pod for the second pod to the new pod.
Example 19 is the system of example(s) 18, wherein the operations further comprise: continuing to add as many pods as necessary to form the satellite service chain.
Example 20 is the system of example(s) 15-19, wherein the first CNI plugin is further configured to assign a first internet protocol (IP) address to the first pod, and wherein the second CNI plugin is further configured to assign a second IP address to the second pod, and so on for all subsequent pods that form the satellite service chain.
Example 21 is the system of example(s) 15-20, wherein each of the first VNF and the second VNF is a virtual receiver, a virtual transmitter, or a combiner, among other possibilities.

### BRIEF DESCRIPTION OF THE DRAWINGS

The accompanying drawings, which are included to provide a further understanding of the disclosure, are incorporated in and constitute a part of this specification, illustrate embodiments of the disclosure and together with the detailed description serve to explain the principles of the disclosure. No attempt is made to show structural details of the disclosure in more detail than may be necessary for a fundamental understanding of the disclosure and various ways in which it may be practiced.

FIG. 1 illustrates an example satellite service chain formed by a set of VNFs running on a compute infrastructure.

FIG. 2 illustrates an example network attachment definition.

FIG. 3 illustrates an example compute infrastructure or cluster having a set of compute nodes running VNFs for a satellite communication system.

FIG. 4 illustrates an example compute infrastructure comprising a set of compute nodes for running a set of workloads.

FIG. 5 illustrates an example communication path between end points enabled by a satellite communication system.

FIG. 6 illustrates an example satellite communication system including a gateway and a set of terminals.

FIG. 7 illustrates an example digital IF packet with multiple protocol layers.

FIG. 8 illustrates an example method of forming a satellite service chain at a compute infrastructure having a set of compute nodes.

FIG. 9 illustrates an example computer system comprising various hardware elements.

In the appended figures, similar components and/or features may have the same numerical reference label. Further, various components of the same type may be distinguished by following the reference label with a letter or by following the reference label with a dash followed by a second numerical reference label that distinguishes among the similar components and/or features. If only the first numerical reference label is used in the specification, the description is applicable to any one of the similar components and/or features having the same first numerical reference label, irrespective of the suffix.

### DETAILED DESCRIPTION OF THE INVENTION

In a satellite communication system, a compute infrastructure may consist of clusters of servers running high-performance workloads generated by satellite operations. These clusters allow for the distribution of computational tasks across multiple servers, enhancing the system's ability to handle large volumes of data transmitted from satellites, such as communications data, telemetry data, and scientific measurements. Clusters can scale dynamically, adjusting the number of active servers based on the incoming data volume and computational demands, which is particularly useful during peak times when satellites transmit higher data loads. As such, the compute infrastructure of a satellite communication system can enhance performance, scalability, and fault tolerance, leading to more robust and responsive satellite operations.

Software elements running on the compute infrastructure may orchestrate placement of incoming workloads onto the compute infrastructure's compute nodes. These software elements may include a workload scheduler and a number of server agents, collectively forming the compute infrastructure's control plane. The server agents may provide information to the workload scheduler on central processing unit (CPU) and memory availability for each physical server in a cluster. This allows the workload scheduler to select a number of servers that can run the workload when a number of CPUs and amount of memory is requested to run the workload. The workload scheduler may select the server with the most available resources and the server agent running on the selected server may run the workload on the compute node with the most available processors and memory.

When satellite workloads are placed onto a compute node, they may be implemented using a pod, such as a Kubernetes pod, which may serve as the smallest deployable unit in the container orchestration platform. The process may involve generating the pod using a configuration file, such as a YAML configuration file. This file specifies details such as the pod's name, container image, resource requirements, and any additional configurations or annotations needed for the workload. The configuration file may include an annotations section, which provides settings for the container network interface (CNI) plugin used to manage the pod's network connections. For satellite workloads, a specialized CNI plugin (e.g., “kratos-nfvo”) may be used to handle advanced networking requirements. In some examples, the annotations specify the network overlay type (e.g., “Azure-SRIOV”) to be used for connecting the pod to the cluster network. This overlay determines how the pod communicates with other compute nodes or pods in the network. The CNI plugin ensures the pod is connected to the appropriate network bridge (e.g., Azure-SRIOV bridge) on the host node.

In some examples, the CNI plugin configures the host node's network interface card (NIC) to support the selected network overlay. This involves assigning the NIC to the bridge and ensuring high-speed data-plane communication between the pod and other compute nodes or pods in the cluster. The pod's network interface may be assigned an IP address through an IP Address Management (IPAM) system (e.g., “azure-vnet-ipam”). This IP address may be used for communication within the compute infrastructure or cluster and allow the satellite workload to interact with other services. In some cases, once the pod is fully configured and networked, it is scheduled and placed onto a specific compute node in the compute infrastructure or cluster. This decision can be made by the scheduler and various agents, based on resource availability and workload requirements as noted above.

The satellite workload then runs within the pod on the compute node, using the configured network settings and resources on the compute node. In some cases, the satellite workload may correspond to a high-performance workload such as a virtual network function (VNF) workload for a satellite communication system. The pod may communicate with other pods as part of a satellite service chain. As used herein, a “satellite service chain” may refer to a network architecture or configuration where multiple interconnected VNFs, running within pods or containers in a compute infrastructure or cluster, work together to provide a specific service or functionality. These VNFs may be organized sequentially or in a specific topology to process and route data between them, forming a “chain” of services.

Embodiments of the present disclosure relate to systems and methods for creating a satellite service chain on a computer infrastructure or cluster using a custom CNI plugin. Each pod or container implementing a VNF in the service chain is created on the compute infrastructure using a configuration file, which defines the configuration for each pod, including their names and settings. The “annotations” section of the configuration file specifies the primary settings the CNI plugin uses to construct the service chain. These settings include directives for using the custom CNI plugin to connect the pod to the cluster network. The network overlay type used for connecting the pods may be defined in the Network Attachment Definition. The defined network overlay connects the pods to a particular bridge (e.g., Azure-SRIOV) on the host node, using the NIC with a specified interface. The bridge is attached to the NIC via a specific port and uses the defined network overlay (e.g., Azure-SRIOV) as its high-speed data-plane network for communication between pods in the service chain. In some instances, the IPAM configuration specifies the use of an IPAM for obtaining IP addresses assigned to the network interface inside the pod's operating system. These configurations enable efficient high-speed communication across the pods that form the service chain.

Many benefits are achieved by way of the present disclosure. For example, with the logic and functionality for creating the satellite service chain residing in the CNI plugin and the service-chain manager entity being transparently injected into the new application containers/pods as they are created, it is possible to enforce or assist in standardization for the way satellite service chains are constructed and how they interconnect with the different high-speed network overlays and protocols. These benefits are even more evident for pods/containers with complex protocols such as SRIOV, DPDK, and the like, which can be extremely complicated to configure correctly. Embodiments allow for the creation and configuration of satellite service chains with the many different types of pods/containers that are found in the satellite industry today.

In the following description, various examples will be described. For purposes of explanation, specific configurations and details are set forth in order to provide a thorough understanding of the examples. However, it will also be apparent to one skilled in the art that the example may be practiced without the specific details. Furthermore, well-known features may be omitted or simplified in order not to obscure the embodiments being described.

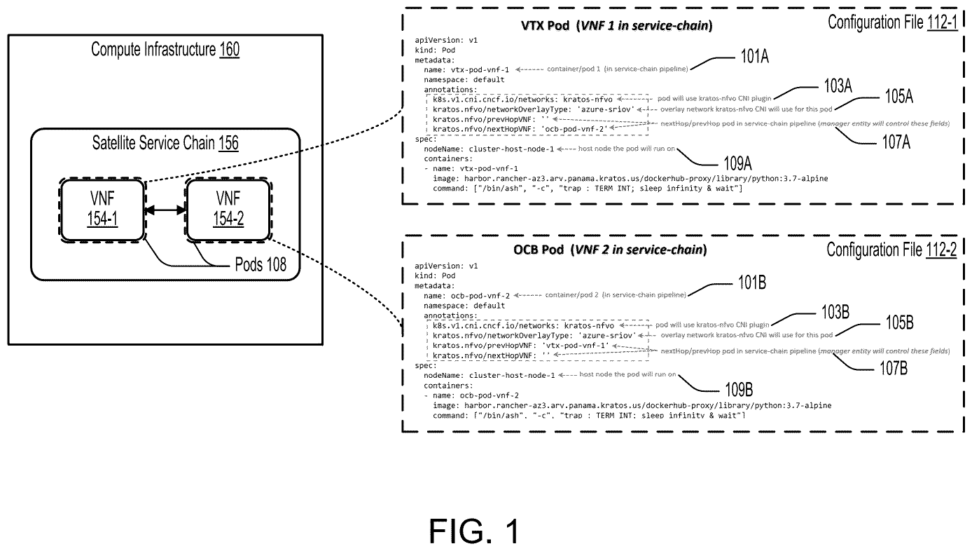

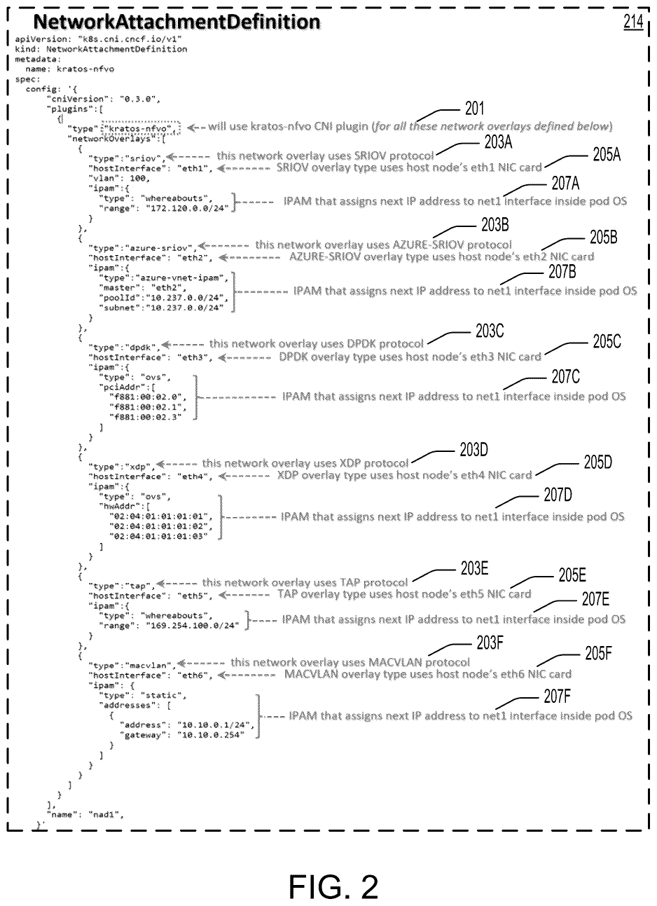

The figures herein follow a numbering convention in which the first digit or digits correspond to the figure number and the remaining digits identify an element or component in the figure. Similar elements or components between different figures may be identified by the use of similar digits. For example, 108 may reference element “08” in FIG. 1, and a similar element may be referenced as 208 in FIG. 2. As will be appreciated, elements shown in the various embodiments herein can be added, exchanged, and eliminated so as to provide a number of additional embodiments of the present disclosure. In addition, the proportion and the relative scale of the elements provided in the figures are intended to illustrate certain embodiments of the present disclosure and should not be taken in a limiting sense.

FIG. 1 illustrates an example satellite service chain 156 formed by a set of VNFs 154 running on a compute infrastructure 160, in accordance with some embodiments of the present disclosure. In some examples, VNFs 154 may be deployed as pods 108 running on compute infrastructure 160. In the illustrated example, VNFs 154 include a first VNF 154-1 corresponding to a virtual transmitter and a second VNF 154-2 corresponding to a combiner. Pods 108 may be generated using configuration files 112, which may be YAML configuration files or another type of configuration file. In some cases, configuration files 112 specify the names of pods 108, resource requirements for pods 108, and any additional configurations or annotations needed for the corresponding workloads. In the illustrated example, configuration files 112 include a first configuration file 112-1 for generating and configuring the pod implementing VNF 154-1 and a second configuration file 112-2 for generating and configuring the pod implementing VNF 154-2.

In reference to configuration file 112-1, line 101A specifies the name of the pod (“vtx-pod-vnf-1”), line 103A specifies the CNI plugin that is to set up the networking for the pod (“kratos-nfvo”), line 105A specifies the overlay network that the CNI plugin will use for the pod (“azure-sriov”), lines 107A specify the previous pod (if any) and the subsequent pod (if any) that are to be connected to the pod to form satellite service chain 156 (no previous pod is specified, subsequent pod is “ocb-pod-vnf-2”), and line 109A specifies the compute node the pod will run on (“cluster-host-node-1”). In reference to configuration file 112-2, line 101B specifies the name of the pod (“ocb-pod-vnf-2”), line 103B specifies the CNI plugin that is to set up the networking for the pod (“kratos-nfvo”), line 105B specifies the overlay network that the CNI plugin will use for the pod (“azure-sriov”), lines 107B specify the previous pod (if any) and the subsequent pod (if any) that are to be connected to the pod to form satellite service chain 156 (previous pod is “vtx-pod-vnf-1”, no subsequent pod is specified), and line 109B specifies the compute node the pod will run on (“cluster-host-node-1”).

FIG. 2 illustrates an example network attachment definition 214, in accordance with some embodiments of the present disclosure. In some examples, network attachment definition 214 fully defines how the cluster network will be configured for a particular CNI plugin. Line 201 specifies the particular CNI plugin (“kratos-nfvo”) to which network attachment definition 214 applies. Thereafter, different network overlap types are listed that are available for the VNFs and pods. Line 203A specifies the network overlay type of “sriov”, line 205A specifies that the “sriov” network overlay type will use the NIC on the host node with interface “eth1”, and lines 207A include the IPAM section that specifies that the “sriov” network overlay type uses “whereabouts” to obtain its IP addresses to assign to the net1 interface inside the pod's operating system.

Line 203B specifies the network overlay type of “azure-sriov”, line 205B specifies that the “azure-sriov” network overlay type will use the NIC on the host node with interface “eth2”, and lines 207B include the IPAM section that specifies that the “azure-sriov” network overlay type uses “azure-vnet-ipam” to obtain its IP addresses to assign to the net1 interface inside the pod's operating system. Line 203C specifies the network overlay type of “dpdk”, line 205C specifies that the “dpdk” network overlay type will use the NIC on the host node with interface “eth3”, and lines 207C include the IPAM section that specifies that the “dpdk” network overlay type uses “ovs” to obtain its IP addresses to assign to the net1 interface inside the pod's operating system.

Line 203D specifies the network overlay type of “xdp”, line 205D specifies that the “xdp” network overlay type will use the NIC on the host node with interface “eth4”, and lines 207D include the IPAM section that specifies that the “xdp” network overlay type uses “ovs” to obtain its IP addresses to assign to the net1 interface inside the pod's operating system. Line 203E specifies the network overlay type of “tap”, line 205E specifies that the “tap” network overlay type will use the NIC on the host node with interface “eth5”, and lines 207E include the IPAM section that specifies that the “tap” network overlay type uses “whereabouts” to obtain its IP addresses to assign to the net1 interface inside the pod's operating system. Line 203F specifies the network overlay type of “macvlan”, line 205F specifies that the “macvlan” network overlay type will use the NIC on the host node with interface “eth6”, and lines 207F include the IPAM section that specifies that the “macvlan” network overlay type uses “static” to obtain its IP addresses to assign to the net1 interface inside the pod's operating system.

As used herein “SRIOV” or “sriov” may refer to Single Root I/O Virtualization, a technology that allows a physical PCIe device to present itself multiple times through the PCIe bus. This technology enables multiple virtual instances of the device with separate resources. SRIOV allows a physical device to share its resources with multiple virtual machines. As used herein “DPDK” or “dpdk” may refer to Data Plane Development Kit, a set of libraries for implementing user-space drivers for network interface controllers. DPDK provides a framework and common API for high-speed networking applications and allows for achieving a fast packet processing pipeline. DPDK includes a set of libraries and drivers to accelerate packet processing that offloads TCP packet processing from the operating system kernel to user-space processes.

As used herein “TAP” or “tap” may refer to Network TAP, which provides packet reception and transmission for user-space programs at layer 2 (Ethernet frames). User-space programs can write raw Ethernet frame data to a file descriptor and the kernel will treat it like any other Ethernet packet it receives on a real physical interface. TAP may simulate a link layer device. TAP devices operate at the Ethernet level and can be used to create a user-space network bridge. As used herein, “XDP” or “xdp” may refer to Express Data Path (XDP) or Address Family Express Data Path (AF_XDP), which are networking technologies in the Linux kernel that allow the execution of custom packet processing logic directly at the network driver level before packets are passed to the kernel's networking stack. A process can create a special socket type under the AF_XDP address family which in combination with an XDP program can perform full or partial kernel bypass where it bypasses the kernel network stack to increase performance. A socket created under the AF_XDP address family can be referred to as a XDP socket.

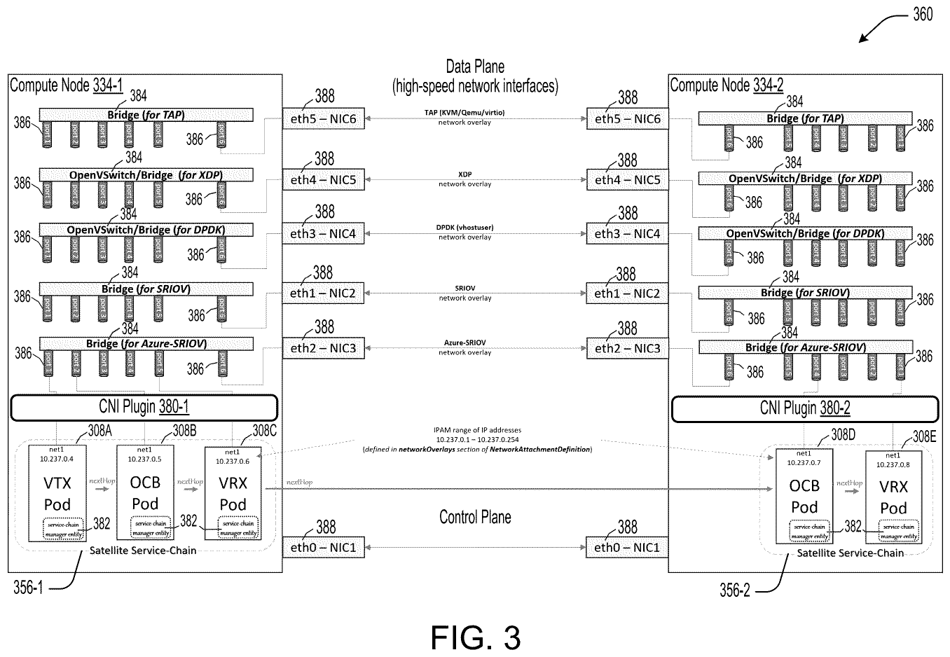

FIG. 3 illustrates an example compute infrastructure 360 or cluster having a set of compute nodes 334 running VNFs (implemented as pods 308) for a satellite communication system, in accordance with some embodiments of the present disclosure. At compute node 334-1, the VNFs implemented by pods 308 form a first satellite service chain 356-1 and, at compute node 334-2, the VNFs implemented by pods 308 form a second satellite service chain 356-2. Satellite service chains 356-1 and 356-2 may be considered a single satellite service chain or, in some examples, as two separate satellite service chains. Compute nodes 334 run respective CNI plugins 380 that manage the network connectivity for pods 308.

At compute node 334-1, a first CNI plugin 380-1 may assign an IP address to each of pods 308 running on compute node 334-1 in accordance with the IPAM specified for the network overlay type. CNI plugin 380-1 may also connect pods 308 running on compute node 334-1 to one of various bridges and Open vSwitches 384 of compute node 334-1. In some examples, bridges and Open vSwitches 384 may be associated with ports 386 of compute node 334-1. In the illustrated example, CNI plugin 380-1 connects pod 308A implementing a virtual transmitter VNF to port 1 of the bridge for “azure-sriov”, pod 308B implementing a combiner VNF to port 2 of the bridge for “azure-sriov”, and pod 308C implementing a virtual receiver VNF to port 5 of the bridge for “azure-sriov”. Port 6 of the bridge for “azure-sriov” is attached to interface eth2 of interfaces 388 of compute node 334-1.

CNI plugin 380-1 may transparently insert a service-chain manager entity 382 into each of pods 308 running on compute node 334-1 for the purpose of managing the creation and ongoing maintenance of satellite service chain 356-1. In some examples, each of service-chain manager entities 382 may use the annotations section of the pod's configuration file to manage the ordering of the pods in satellite service chain 356-1 by controlling which pod a current pod should be communicating with as its subsequent pod (“nextHop”). In the illustrated example, service-chain manager entity 382 inserted into pod 308A may modify the configuration file for pod 308A such that the previous pod is set to null and the subsequent pod is set to pod 308B, service-chain manager entity 382 inserted into pod 308B may modify the configuration file for pod 308B such that the previous pod is set to pod 308A and the subsequent pod is set to pod 308C, and service-chain manager entity 382 inserted into pod 308C may modify the configuration file for pod 308C such that the previous pod is set to pod 308B and the subsequent pod is set to pod 308D running on compute node 334-2.

At compute node 334-2, a second CNI plugin 380-2 may assign an IP address to each of pods 308 running on compute node 334-2 in accordance with the IPAM specified for the network overlay type. CNI plugin 380-2 may also connect pods 308 running on compute node 334-2 to one of bridges and Open vSwitches 384 of compute node 334-2. In some examples, bridges and Open vSwitches 384 may be associated with ports 386 of compute node 334-2. In the illustrated example, CNI plugin 380-2 connects pod 308D implementing a combiner VNF to port 4 of the bridge for “azure-sriov” and pod 308E implementing a virtual receiver VNF to port 1 of the bridge for “azure-sriov”. Port 6 of the bridge for “azure-sriov” is attached to interface eth2 of interfaces 388 of compute node 334-2.

CNI plugin 380-2 may transparently insert a service-chain manager entity 382 into each of pods 308 running on compute node 334-2 for the purpose of managing the creation and ongoing maintenance of satellite service chain 356-2. In some examples, each of service-chain manager entities 382 may use the annotations section of the pod's configuration file to manage the ordering of the pods in satellite service chain 356-2 by controlling which pod a current pod should be communicating with as its subsequent pod (“nextHop”). In the illustrated example, service-chain manager entity 382 inserted into pod 308D may modify the configuration file for pod 308D such that the previous pod is set to pod 308C and the subsequent pod is set to pod 308E and service-chain manager entity 382 inserted into pod 308E may modify the configuration file for pod 308E such that the previous pod is set to pod 308D and the subsequent pod is set to null.

Using service-chain manager entities 382, CNI plugins 380 may add or remove pods and corresponding VNFs from satellite service chains 356. In one example, it may be desired to add a virtual transmitter VNF to satellite service chain 356-2 to run alongside the existing combiner VNF (implemented by pod 308D) and virtual receiver VNF (implemented by pod 308E). A pod for the virtual transmitter VNF may be generated using an initial configuration file constructed by compute infrastructure 360. Before or after the new pod begins running on compute node 334-2, CNI plugin 380-2 may modify the configuration file (e.g., using a service-chain manager entity 382) of the new pod to set the previous pod to pod 308C and the subsequent pod to pod 308D, and the configuration file (e.g., using a service-chain manager entity 382) of pod 308D to set the previous pod to the new pod, thereby adding the new pod to satellite service chain 356-2. To properly connect satellite service chains 356, CNI plugin 380-1 may modify the configuration file (e.g., using a service-chain manager entity 382) of pod 308C to set the subsequent pod to the new pod. In some examples, satellite service chains 356-1 and 356-2 may be considered a single satellite service chain. As such, a single satellite service chain may include pods and corresponding VNFs running on separate compute nodes.

In another example, it may be desired to remove the existing combiner VNF (implemented by pod 308D) from satellite service chain 356-2. Prior to removing pod 308D from compute node 334-2, CNI plugin 380-2 may modify the configuration file (e.g., using a service-chain manager entity 382) of pod 308E to set the previous pod to pod 308C and CNI plugin 380-1 may modify the configuration file (e.g., using a service-chain manager entity 382) of pod 308C to set the subsequent pod to pod 308E, thereby removing pod 308D from satellite service chain 356-2 and the collective satellite service chain formed by the union of satellite service chains 356-1 and 356-2. After removing network connections, pod 308D may be terminated on compute node 334-2. Additional pods and corresponding VNFs may be added and removed from satellite service chains 356 in the above-described manner. Furthermore, the ordering of pods and corresponding VNFs within satellite service chains 356 may be modified in a similar manner.

Pods 400 and corresponding VNFs in the satellite service chain may communicate over the data plane via the bridges and NICs specified in the configuration files for pods 400. To communicate over different bridges and different NICs, i.e., to switch from communicating over a set of first bridges and first NICs to communicating over a set of second bridges and second NICs, these configuration files may be modified by CNI plugins 380 (e.g., using service-chain manager entities 382) in real time while pods 308 are running and satellite service chains 356 are operational. Communication between CNI plugins 380 can be performed over the control plane, which compute infrastructure 360 uses to run and manage the cluster itself. For example, CNI plugin 380-2 (e.g., using service-chain manager entities 382) may communicate with CNI plugin 380-1 (e.g., using service-chain manager entities 382) via the control plane regarding changes needed to be made to the configuration files of pods 308A, 308B, or 308C when a new pod is added or removed from satellite service chain 356-2. Similarly, CNI plugin 380-1 (e.g., using service-chain manager entities 382) may communicate with CNI plugin 380-2 (e.g., using service-chain manager entities 382) via the control plane regarding changes needed to be made to the configuration files of pods 308D or 308E when a new pod is added or removed from satellite service chain 356-1.

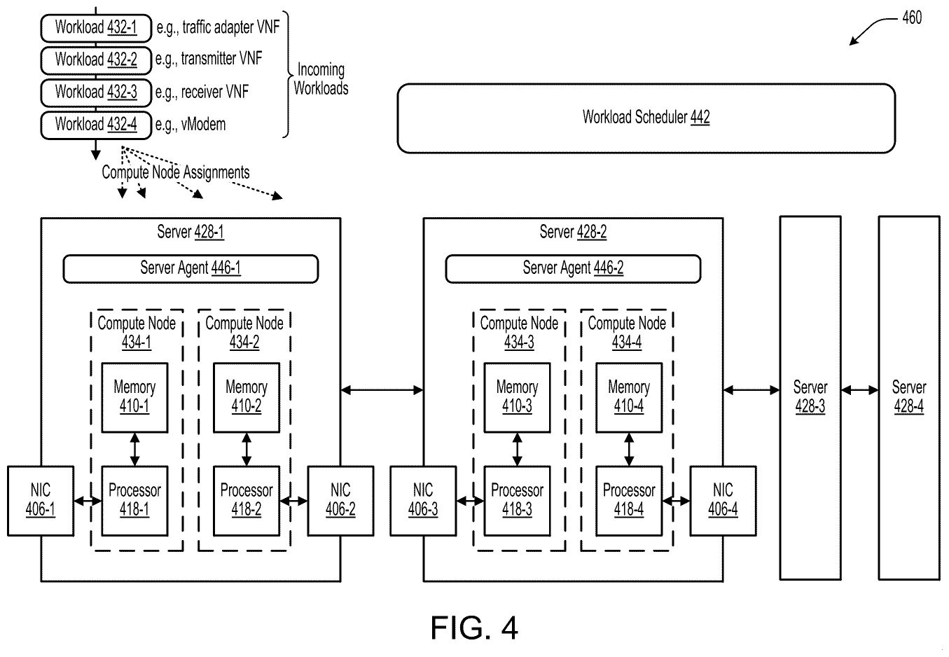

FIG. 4 illustrates an example compute infrastructure 460 comprising a set of compute nodes 434 for running a set of workloads 432, in accordance with some embodiments of the present disclosure. In some examples, compute infrastructure 460 may correspond to a cluster of a cloud computing architecture having a set of servers 428. Each of servers 428 may include one or more compute nodes 434 connected to one or more NICs 406. Each of compute nodes 434 may include one or more processors 418 connected to one or more memories 410 via a memory bus. For example, each of processors 418 may correspond to a central processing unit (CPU) or a multiprocessor having multiple processor cores that may be assigned to run one or more of workloads 432. Compute nodes 434 may be distributed between different servers 428 within compute infrastructure 460, such as two compute nodes 434 for each server 428.

In some examples, each of compute nodes 434 corresponds to a non-uniform memory access (NUMA) node within a NUMA architecture, where the memory access time depends on the memory location relative to a processor. For example, processor 418-1 may access memory 410-1 (which is within the same compute node) in accordance with a first memory access time, memory 410-2 (which is part of a different compute node within the same server) in accordance with a second memory access time that is greater than the first memory access time, and memory 410-3 (which is part of a different compute node and a different server) in accordance with a third memory access time that is greater than the first and second memory access times. Compute infrastructure 460 can optimize the performance of workloads 432 that are sensitive to memory latency by strategically placing these workloads on specific compute nodes 434 (or NUMA nodes) to maximize the use of local memory accesses.

Compute infrastructure 460 may include a workload scheduler 442 that assigns incoming workloads 432 to servers 428 within compute infrastructure 460. Workload scheduler 442 may ensure that each of workloads 432 is placed on a server that can provide the necessary resources while also adhering to a set of constraints and requirements, some of which may be defined by a workload specification for each of workloads 432. When a new workload needs to be scheduled, workload scheduler 442 determines the current state of the servers by receiving a server status from each of a set of server agents 446 running on servers 428. By analyzing the server statuses, workload scheduler 442 can identify which servers have sufficient resources (CPU, memory, disk, etc.) to accommodate the workload. This assessment may include checking resource requests and limits specified in the workload specification against the available resources on each server.

Workload scheduler 442 may also consider various constraints and affinity/anti-affinity specifications. These rules can be set to ensure that workloads 432 are placed on servers 428 and compute nodes 434 that meet specific requirements or preferences. For example, some of workloads 432 may need to be co-located on the same server or compute node for performance reasons, while others might need to be spread across different servers or compute nodes for high availability and redundancy. Workload scheduler 442 may aim to balance the load across compute infrastructure 460 effectively to maintain overall performance and stability. Once workload scheduler 442 has evaluated all factors, it selects the most appropriate server and node for the workload and assigns the workload to that server and node. Workload scheduler 442 may operate continuously as new workloads are created and old workloads are destroyed.

Compute infrastructure 460 may include a set of server agents 446 running on respective servers 428. Each server agent acts as a bridge between workload scheduler 442 and compute nodes 434, managing the state and operation of compute nodes 434 running on that server. Server agents 446 ensure that workloads 432 get assigned to compute nodes 434 and that they have started and are running and healthy. Server agents 446 continuously monitor the resource usage of workloads 432 running on compute nodes 434 within the server, including processor usage, memory usage, NIC bandwidth usage, and memory bandwidth usage. This information is reported back to workload scheduler 442 as a server status. This data helps in scheduling decisions and in maintaining the desired state of compute infrastructure 460.

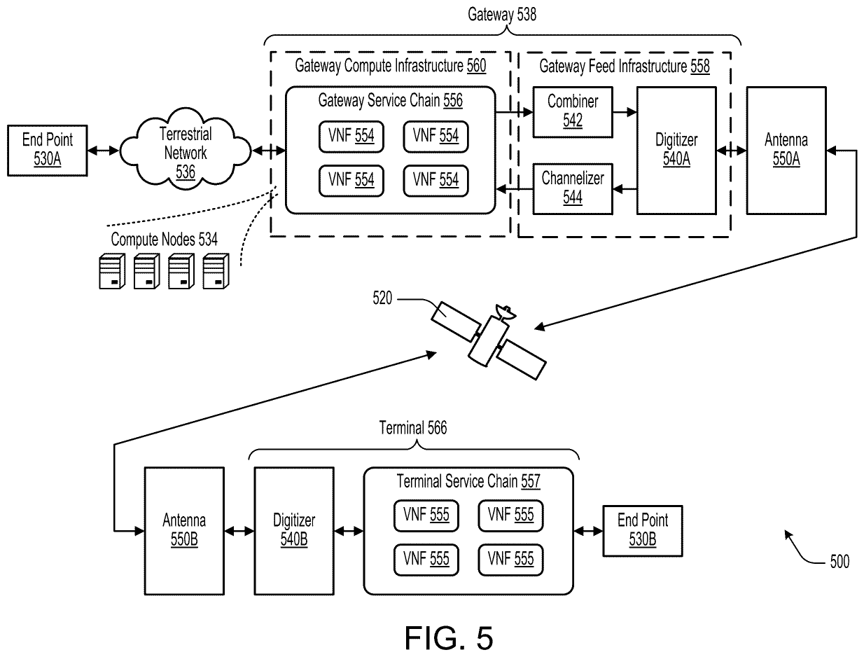

FIG. 5 illustrates an example communication path between an end point 530A and an end point 530B enabled by a satellite communication system 500, in accordance with some embodiments of the present disclosure. In the illustrated example, satellite communication system 500 includes a gateway 538 in communication with a terminal 566 via a satellite 520. In various examples, satellite 520 may send and receive wireless signals within one or more bands of a number of possible frequency bands between 1-300 GHz including, for example, 1 GHz and 300 GHz, including L Band (1-2 GHz), C-Band (4-8 GHz), X-Band (8-12 GHz), Ku-Band (12-18 GHz), Ka-Band (26.5-40 GHz), S-Band (2-4 GHz), and V-Band (40-75 GHz).

In various examples, end points 530 may correspond to portable mobile devices, internet of things (IoT) devices, desktop computers, user terminals, or any of a number of devices with communication capabilities. Alternatively, end points 530 may correspond to networks such as mobile towers, mining sites, ships, planes, or the like. In one example, end point 530A may correspond to a service and end point 530B may correspond to a consumer. It should be understood that the satellite communication environment may comprise other end points 530 and/or other arrangements of components than those illustrated. Furthermore, multiple communication paths may be constructed and operated in parallel, and separate communication paths may have different arrangements from each other.

End point 530A may be communicatively connected via a terrestrial network 536 (e.g., comprising the Internet, a private telecom backbone, or a cloud compute center) to a gateway 538. Gateway 538 may include one or more switches (not shown) to facilitate communication between the various components, such as a first switch at the boundary between terrestrial network 536 and a gateway compute infrastructure 560, and a second switch at the boundary between gateway compute infrastructure 560 and a gateway feed infrastructure 558. Such switches may be physical or virtual Gigabit Ethernet (GigE) switches. However, it should be understood that the above-described first and second switches could be implemented in the same switch. In some examples, the first switch may implement transport from terrestrial network 536 to a VNF 554 within a gateway service chain 556. In such a case, VNF 554 may act as a User Network Interface (UNI) or an External Network-Network Interface (ENNI) as defined by the applicable MEF Ethernet services and MEF operator services standards. Alternatively, the first switch may itself represent the UNI as defined by the applicable MEF standards.

Gateway compute infrastructure 560 may include a set of compute nodes 534 situated onsite (at a same physical location) or offsite (at a different physical location) relative to antenna 550. In some examples, compute nodes 534 may comprise general-purpose computers or servers capable of running VNFs 554 (e.g., as workloads) and other virtualization software such as hypervisors to support gateway service chain 556. In some examples, compute nodes 534 may employ x86 architectures, ARM architectures, RISC-V architectures, among other possibilities. Compute nodes 534 may be configured as clusters, data centers, warehouse-scale computers, among other possibilities. Gateway compute infrastructure 560 may further include suitable storage systems that provide persistent and reliable storage in support of VNFs 554.

In some examples, gateway compute infrastructure 560 may include a managing system that instantiates and configures one or more VNFs 554 to form gateway service chain 556. Two sets of one or more VNFs 554 may provide two-way communication, including a transmission path and a reception path, between terrestrial network 536 and a gateway feed infrastructure 558 of gateway 556. It should be understood that in an example in which gateway service chain 556 provides only one-way communication, VNFs 554 may provide only a transmission path without providing a reception path. The set of VNFs 554 (e.g., implementing a gateway) on the forward path towards the link to satellite 520, may comprise or constitute a traffic handler, an encapsulator (e.g., implementing generic stream encapsulation (GSE)), a modulator (e.g., the OpenSpace™ Wideband Software modulator, offered by Kratos Defense & Security Solutions, Inc. of San Diego, California), a combiner, an encryption/decryption VNF, a time division multiple access (TDMA) resource allocator, an antenna controller, among other possibilities.

This set of VNFs 554 on the transmission path may convert protocol data units (PDUs) into a digital signal (such as a digital intermediate frequency (IF) waveform or a composite digital IF waveform). For example, the traffic handler may process data link layer (e.g., Layer 2 or L2 in the Open Systems Interconnection (OSI) model) and/or network layer (e.g., Layer 3 or L3 in the OSI model) traffic, and provide the processed Ethernet frames or IP packets to the encapsulator. The encapsulator may convert the PDUs into baseband frames, and provide the baseband frames to the modulator. A baseband frame may be the basic unit of transmission in satellite communication system 500. The encapsulator may form baseband frames in accordance with the 5G standard, the DVB-S2x standard, described in European Telecommunications Standards Institute (ETSI) European Standard (EN) 302 307-1 v 1.4.1 (2014 November ), among other possible standards. The encapsulator may comprise one or more VNFs 554 (or software subprocesses) that perform one or more of the following functions: frame chopping, forward modulation selection (e.g., with Adaptive Coding and Modulation (ACM)), Ethernet bridge (e.g., Media Access Control (MAC) table, smart bridging/learning/relay, etc.), Address Resolution Protocol (ARP) (e.g., Ethernet MAC discovery), VLAN manipulation (e.g., to rewrite Ethernet frames on ingress/egress based on the MEF service definition), header compression (e.g., Robust Header Compression (ROHC)); and/or OTA optimization (e.g., Space Communications Protocol Specifications (SCPS)/TCP-Acceleration). The modulator may convert the baseband frames into signal data packets in accordance with a particular standard, including the standards of the Digital Intermediate Frequency Interoperability (DIFI) Consortium in the DIFI/Institute of Electrical and Electronics Engineers (IEEE) 1.0 specification, the VMEbus International Trade Association (VITA) standard, the enhanced Common Public Radio Interface (eCPRI) standard, among other possibilities. In an embodiment, the encapsulator and the traffic handler may be implemented as a single VNF 554, referred to as a virtualized traffic adaptor (vModem). The VNF-implemented combiner or a combiner 542 (implemented in hardware) may combine the signal data packets into a digital signal and provide the digital signal to a digitizer 540A, which may convert the digital signal into an analog signal.

The set of VNFs 554 on the return path may comprise or constitute, in order, a digital channelizer (e.g., the OpenSpace™ Wideband Channelizer, offered by Kratos Defense & Security Solutions, Inc. of San Diego, California), a demodulator (e.g., the OpenSpace™ Wideband Software Receiver, offered by Kratos Defense & Security Solutions, Inc. of San Diego, California), and a decapsulator. This set of VNFs 554 on the reception path may convert a digital signal (such as a digital IF waveform or a composite digital IF waveform) to PDUs, which may be Ethernet frames or IP packets, among other possibilities. For example, the VNF-implemented channelizer or a channelizer 544 (implemented in hardware) may receive a digital signal from digitizer 540A, which has converted an analog signal into the digital signal, and divide the digital signal into signal data packets. The demodulator may convert the signal data packets to baseband frames, and provide the baseband frames to the decapsulator. The decapsulator may convert the baseband frames into PDUs, which may be transmitted, via terrestrial network 536, to end point 530A. It should be understood that the demodulator performs the reverse function(s) of the modulator, and the decapsulator performs the reverse function(s) of the encapsulator. In an embodiment, the decapsulator and demodulator may be implemented as a single VNF 554, for example, together with the traffic handler, encapsulator, and modulator, in a vModem. In other words, a vModem may consist of a single VNF 554 that implements all of the functions of the traffic handler, encapsulator/decapsulator, and modulator/demodulator.

In some embodiments, in which gateway service chain 556 implements a vModem, the vModem may comprise one or more modulators that are configured to modulate waveforms according to a digital satellite broadcast standard and/or one or more demodulators that are configured to demodulate waveforms according to a digital satellite broadcast standard. Such a vModem may provide carrier ethernet (CE) services, in which case the vModem may comprise one or more encapsulators that convert Ethernet frames into baseband frames that are modulated into waveforms by the modulator(s), and one or more decapsulators that convert baseband frames, which have been demodulated from waveforms by the demodulator(s), into Ethernet frames. The digital satellite broadcast standard may be a digital satellite television broadcast standard, such as the DVB-S2X standard managed by the Digital Video Broadcasting (DVB) Project. While a digital satellite broadcast standard, such as a DVB standard, is used as an example, the vModem may be configured to modulate and demodulate waveforms according to other standards for wideband digital communication, such as orthogonal frequency-division multiplexing (OFDM), or the like.

The digital signal from combiner 542 is transmitted to digitizer 540A, which converts the digital signal output by combiner 542 into an analog transmission signal for communication to satellite 520. Digitizer 540A further digitizes analog reception signals from satellite 520 into digital signals for use by channelizer 544. In some examples, digitizer 540A may be software-defined. As one example, digitizer 540A may be a SpectralNet™, which is a carrier-grade RF digitizer, offered by Kratos Defense & Security Solutions, Inc. of San Diego, California. Digitizer 540A communicates with antenna 550A. In particular, digitizer 540A provides the transmission signal to antenna 550A, which transmits the transmission signal to satellite 520. In addition, in two-way communications, antenna 550A receives a reception signal from satellite 520, and provides the reception signal to digitizer 540A.

In various examples, antenna 550A may be a parabolic reflector antenna, a flat panel antenna, a phased array antenna, a helical antenna, a patch antenna, a horn antenna, among other possibilities. In some examples, antenna 550A may be an electronically steered antenna that can use electronic means to control the direction and shape of its radiation pattern. Such an antenna can generate multiple beams simultaneously, allowing it to transmit or receive signals in multiple directions at the same time. Antenna 550A may include both the physical antenna as well as the corresponding radio frequency (RF) subsystem, which may include a combination of diplexers, amplifiers (e.g., low noise amplifiers (LNAs)), upconverters, and downconverters (e.g., low-noise block downconverters (LNBs) depending on the specific frequency band and application.

Satellite 520 relays wireless signals from antenna 550A to antenna 550B. In two-way communications, satellite 520 also relays wireless signals from antenna 550B to antenna 550A. Antenna 550B may be functionally similar or identical to antenna 550A, and therefore, any description of antenna 550A applies equally to antenna 550B, which may not be redundantly described herein. Similarly, digitizer 540B may be functionally similar or identical to digitizer 540A, and therefore, any description of digitizer 540A applies equally to digitizer 540B, which may not be redundantly described herein.

Digitizer 540B may communicate directly with a terminal service chain 557 of a terminal compute infrastructure. Terminal service chain 557 may comprise a set of VNF(s) 555 forming a reception path from digitizer 540B to end point 530B. In two-way communications, terminal service chain 557 may also comprise a set of VNFs 555 forming a transmission path from end point 530B to digitizer 540B. The reception and transmission paths may be identical or similar to the reception and transmission paths described with respect to gateway service chain 556. For example, the reception path may comprise a demodulator followed by a decapsulator to convert signal frames into PDUs, and the transmission path may comprise an encapsulator followed by a modulator to convert PDUs into signal frames. The traffic handler, encapslator, decapsulator, modulator, and demodulator may all be similar or identical to those described with respect to gateway service chain 556, and therefore, the descriptions of those components with respect to gateway service chain 556 apply equally to those components in terminal service chain 557.

Terminal service chain 557 may communicate with end point 530B. For example, the traffic handler of terminal service chain 557 may transmit Ethernet frames to end point 530B. In addition, in two-way communications, the encapsulator of terminal service chain 557 may receive PDUs from end point 530B. Thus, the combination of gateway service chain 556 and terminal service chain 557 enable one-way or two-way communications between end points 530A and 530B over a satellite link.

Gateway service chain 556 and terminal service chain 557 may comprise one or more of the software-defined components (e.g., VNFs and/or digitizers) described in International Patent App. Nos. PCT/US2021/033867, filed on May 24, 2021, PCT/US2021/033875, filed on May 24, 2021, PCT/US2021/033905, filed on May 24, 2021, and PCT/US2021/062689, filed on Dec. 9, 2021, which are all hereby incorporated herein by reference as if set forth in full.

Advantageously, the utilization of VNFs and software-defined components (e.g., digitizers 540A and 540B) to perform various functions, aid in automation and scalability. Embodiments may minimize the presence of physical hardware components, such that satellite communication system 500 can be dynamically reconfigured (e.g., added, updated, destroyed, increased or decreased in dimension, etc.) in real time, primarily using in-band network communications, to adapt to the unique multivariate satcom environment (e.g., changing traffic patterns, RF interference, atmospheric characteristics, antenna conditions, path length, etc.).

Notably, dynamic reconfiguration of VNFs in a cloud computing environment can be used, not only to increase the dimensions of the computing resources (e.g., number of vCPUs, amount of memory and/or disk storage, network throughput, etc.) used for satellite communication system 500 on demand to ensure the sufficiency of the satellite communication system, but also to decrease the dimensions of the computing resources on demand to optimize the utilization of the hardware. For example, favorable changes in the satcom environment may improve performance of satellite communication system 500, such that satellite communication system 500 is providing significantly better performance than is required by the service level agreement. In this case, the management system may determine that gateway service chain 556 and terminal service chain 557 are insufficient, and update the service chains to reduce the resources used in the service chains (e.g., by reducing RF bandwidth usage, resizing one or more VNFs, swapping to a service chain with reduced dimensions, etc.). This is in contrast to conventional hardware-based service chains in which unused resources would simply be idled or otherwise ignored, representing a sunk cost that cannot be recouped.

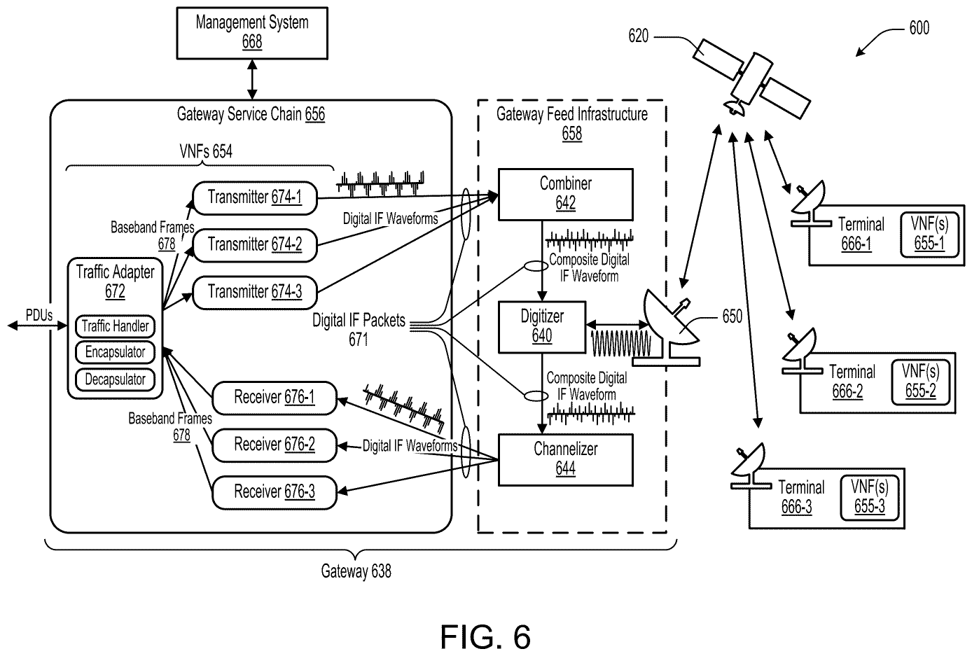

FIG. 6 illustrates an example satellite communication system 600 including a gateway 638 and a set of terminals 666 (or “remote terminals”), in accordance with some embodiments of the present disclosure. In the illustrated example, satellite communication system 600 includes a gateway 638 (or “hub”) in communication with each of terminals 666 via a satellite 620. Gateway 638 may include a gateway feed infrastructure 658 that serves as an onsite infrastructure (close to antenna 650, e.g., at a same physical location) that may perform primarily signal digitization and signal routing-related tasks and a gateway compute infrastructure that can be onsite or offsite infrastructure (far from antenna 650, e.g., at a different physical location) that supports a gateway service chain 656 that performs primarily signal processing and packet processing-related tasks. The gateway compute infrastructure may include one or more computers, clusters, a data center, or a warehouse-scale computer. The compute nodes comprising the gateway compute infrastructure and/or gateway feed infrastructure 658 may include general-purpose computers or servers employing x86 architectures, ARM architectures, RISC-V architectures, among other possibilities.

Gateway 638 may include a gateway service chain 656 comprising a set of VNFs 654 running on the gateway compute infrastructure. Examples of VNFs 654 include one or more traffic adapters 672, one or more virtual transmitters 674, one or more virtual receivers 676, among other possibilities. Each of VNFs 654 may be instantiated and configured by a management system 668 that scales up or down the number of active VNFs based on the number of active terminals 666. Management system 668 may further configure VNFs 654 such that satellite communication system 600 implements any one of a number of network topologies, including a single channel per carrier (SCPC) network, a TDMA network, a frequency division multiple access (FDMA) network, a mesh network, among other possibilities.

Traffic adapter 672 acts as the bridge between the terrestrial network and the satellite network. In some examples, traffic adapter 672 may include a traffic handler that processes data link layer (e.g., Layer 2 in the OSI model) and/or network layer (e.g., Layer 3 in the OSI model) traffic and provides the processed PDUs to the encapsulator, which convert the PDUs into baseband frames 678 and provides baseband frames 678 to one of virtual transmitters 674. On the reception path, baseband frames 678 produced by virtual receivers 676 are received by the decapsulator of traffic adapter 672. The decapsulator may convert baseband frames 678 into Ethernet frames and pass the Ethernet frames to the traffic handler, which processes and provides the Ethernet frames to a terrestrial network.

Virtual transmitters 674 provide transmission paths between a terrestrial network and a gateway feed infrastructure 658 of gateway 656. Each of virtual transmitters 674 on a transmission path may comprise or constitute a forward error correction (FEC) encoder that adds redundant bits according to a particular error-correcting code and a modulator (e.g., the OpenSpace™ Wideband Software modulator) that converts incoming baseband frames 678 into digital IF packets 671 containing digital waveforms at IF or RF frequencies (or “digital IF waveforms”). Each of virtual transmitters 674 may implement a modulator that converts baseband frames 678 into digital IF packets 671 (e.g., according to the standards of the DIFI Consortium in the DIFI/IEEE 1.2 specification) to create the digital IF waveforms.

Digital IF packets 671 generated by virtual transmitters 674 may be fed into a combiner 642 that combines the multiple digital IF waveforms into a single composite signal (or “composite digital IF waveform”). Digital IF packets 671 containing the composite digital IF waveform is fed into a digitizer 640 that converts the digital signal into an analog signal in preparation for wireless transmission via an antenna 650. While combiner 642 is illustrated in FIG. 6 as being an element of gateway feed infrastructure 658, it is to be understood that a combiner VNF (or multiple combiner VNFs) may be instantiated by management system 668 to perform similar functionality.

On the reception path, digitizer 640 digitizes analog signals received from satellite 620 to generate digital IF packets 671 containing digital IF waveforms (e.g., a composite digital IF waveform) of the received analog signals for use by a channelizer 644. The composite digital IF waveform received by channelizer 644 may be a wide-band spectrum (e.g., 100 MHz, 500 MHz, 300 GHz, etc.) that may contain several signals within that segment of the frequency band. In some instances, channelizer 644 divides the composite digital IF waveform into separate digital IF waveforms and sends the waveforms (in the form of digital IF packets 671) to appropriate virtual receivers 676. While channelizer 644 is illustrated in FIG. 6 as being an element of gateway feed infrastructure 658, it is to be understood that a channelizer VNF (or multiple channelizer VNFs) may be instantiated by management system 668 to perform similar functionality.

Virtual receivers 676 provide reception paths between gateway feed infrastructure 658 and a terrestrial network. Each of the set of virtual receivers 676 on a reception path may comprise or constitute a demodulator (e.g., the OpenSpace™ Wideband Software Receiver) that converts incoming digital IF packets 671 containing digital IF waveforms into baseband frames 678 and an FEC decoder that receives the output of the demodulator and uses the redundant bits added by the FEC encoder to identify and correct any errors introduced during transmission. Baseband frames 678 produced by virtual receivers 676 are sent to the decapsulator of traffic adapter 672, which are then converted into Ethernet frames that are passed by the traffic handler to a terrestrial network.

Satellite 620 relays wireless signals from antenna 650 to the antennas of terminals 666, or vice versa. In two-way communications, satellite 620 also relays wireless signals from the antennas of terminals 666 to antenna 650. In some examples, each of terminals 666 may include hardware infrastructure to support one or more VNFs 655. In some examples, VNFs 655 at each of terminals 666 may implement a vModem that comprises one or more modulators that are configured to modulate waveforms according to a digital satellite broadcast standard and/or one or more demodulators that are configured to demodulate waveforms according to the digital satellite broadcast standard. Such a vModem may provide CE services, in which case the vModem may comprise one or more encapsulators that convert Ethernet frames into baseband frames that are modulated into waveforms by the modulator(s), and one or more decapsulators that convert baseband frames, which have been demodulated from waveforms by the demodulator(s), into Ethernet frames, together with a traffic handler that connects the encapsulators and decapsulators with the terrestrial networks connected to terminals 666.

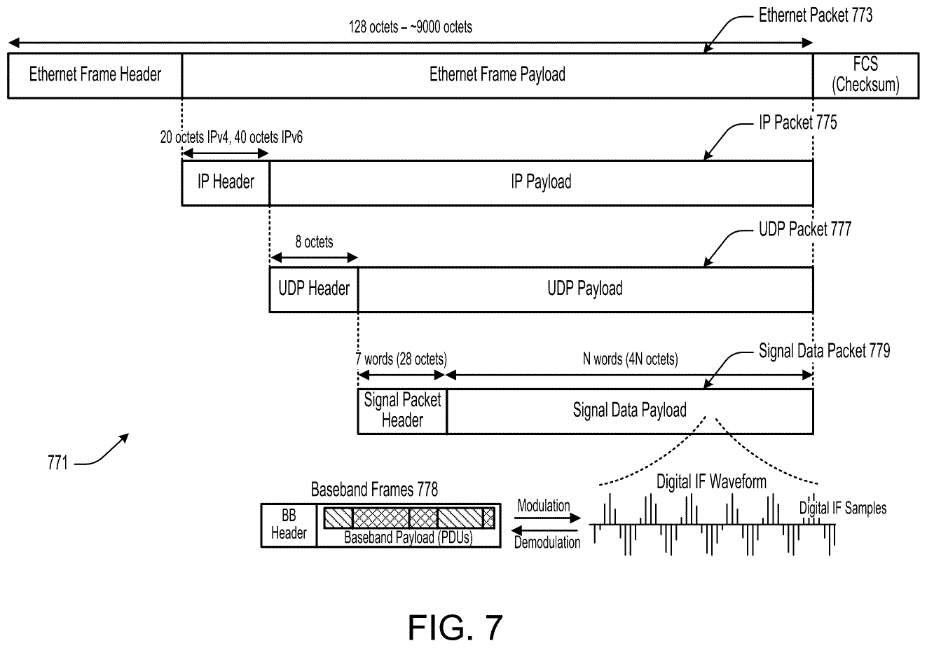

FIG. 7 illustrates an example digital IF packet 771 with multiple protocol layers, in accordance with some embodiments of the present disclosure. In the illustrated example, digital IF packet 771 includes a digital IF waveform contained within the signal data payload of a signal data packet 779. The digital IF waveform may represent the modulated form of one or more baseband frames 778 (or portions of one or more baseband frames 778), such that the baseband frames may be recovered by demodulating the digital IF waveform contained within the signal data payload. Signal data packet 779 may also include a signal packet header, which may implement the VITA standard (e.g., VITA 49.2 specification) or another standard.

In some examples, signal data packet 779 is encapsulated within a UDP packet 777 having a UDP header and UDP payload. UDP packet 777 may be encapsulated within an IP packet 775 having an IP header and IP payload, which may be encapsulated within an Ethernet packet 773 having an Ethernet frame header and Ethernet frame payload. In some examples, the total Ethernet packet size varies based on the number and size of the data samples in the signal data payload of signal data packet 779. There may be a fixed overhead within the Ethernet frame which comprises the IP header (20 octets for IPv 4 or 40 octets (minimum) for IPv 6), the UDP header (8 octets), the signal packet header (28 octets). In some examples, the Ethernet frame payload is adjustable from 128 octets to approximately 9000 octets.

In some examples, digital IF packet 771 may include different packet classes for signal data packet 779. In a first packet class, signal data packet 779 may be a regular data packet that includes the data for the digital samples forming the digital IF waveform. In a second packet class, signal data packet 779 may be a context packet that includes data to ensure standardization of the transport of metadata describing the sampled signal data. Such data may include the IF reference frequency, the sample rate, the bit depth, the equivalent analog bandwidth of the signal represented by the digital stream, the frequency offset of the center of the band occupied by the signal from the IF reference frequency, among other possibilities. In a third packet class, signal data packet 779 may be a command packet that includes data used to provide and acknowledge device settings and support control of timing to permit synchronization of upstream or downstream devices.

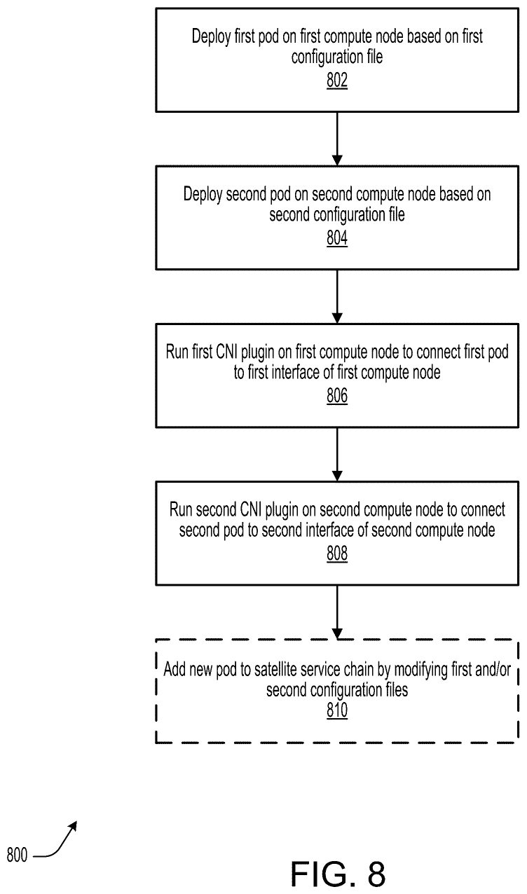

FIG. 8 illustrates an example method 800 of forming a satellite service chain at a compute infrastructure having a set of compute nodes, in accordance with some embodiments of the present disclosure. Steps of method 800 may be performed in any order and/or in parallel, and one or more steps of method 800 may be optionally performed. One or more steps of method 800 may be performed by one or more processors. Method 800 may be implemented as a computer-readable medium or computer program product comprising instructions which, when the program is executed by one or more processors, cause the one or more processors to carry out the steps of method 800.

At step 802, a first pod (e.g., pods 108, 308) is deployed on a first compute node (e.g., compute nodes 334, 434, 534) of a compute infrastructure (e.g., compute infrastructures 160, 360, 460, 560) based on a first configuration file (e.g., configuration file 112-1). The first pod may implement a first VNF (e.g., VNFs 154-1, 554, 654). The first VNF may be a virtual receiver, a virtual transmitter, a combiner, among other possibilities. The first configuration file may specify a previous pod and a subsequent pod for the first pod in a satellite service chain (e.g., satellite service chains 156, 356, 556, 656). While operating within the satellite service chain, the first pod may receive data from the previous pod and transmit data to the subsequent pod.

At step 804, a second pod (e.g., pods 108, 308) is deployed on a second compute node (e.g., compute nodes 334, 434, 534) of the compute infrastructure based on a second configuration file (e.g., configuration file 112-2). The second pod may implement a second VNF (e.g., VNFs 154-2, 554, 654). The second VNF may be a virtual receiver, a virtual transmitter, a combiner, among other possibilities. The second configuration file may specify a previous pod and a subsequent pod for the second pod in the satellite service chain. While operating within the satellite service chain, the second pod may receive data from the previous pod and transmit data to the subsequent pod.

At step 806, a first CNI plugin (e.g., CNI plugin 380-1) is run on the first compute node. The first CNI plugin may be configured to connect the first pod to a first interface of a set of interfaces (e.g., interfaces 388) of the first compute node in accordance with the first configuration file. The first configuration file may further specify a network overlay type. The first CNI plugin may be configured to connect the first pod to a port on a particular bridge (e.g., bridges 384) of the first compute node associated with the network overlay type. A different port on the particular bridge may be connected to the first interface. The first interface may include a first NIC (e.g., NICs 406).

At step 808, a second CNI plugin (e.g., CNI plugin 380-2) is run on the second compute node. The second CNI plugin may be configured to connect the second pod to a second interface of a set of interfaces (e.g., interfaces 388) of the second compute node in accordance with the second configuration file. The second configuration file may further specify the network overlay type. The second CNI plugin may be configured to connect the second pod to a port on a particular bridge (e.g., bridges 384) of the second compute node associated with the network overlay type. A different port on the particular bridge may be connected to the second interface. The second interface may include a second NIC (e.g., NICs 406). The first NIC and the second NIC may be communicatively coupled to form a data plane.

Upon connecting the first and second pods to the first and second interfaces, the pods may communicate data with each other via the interfaces. Data may be communicated in a unidirectional (e.g., from the first pod to the second pod) or a bidirectional manner. In various examples, the data communicated between the first and second pods may include PDUs, baseband frames (e.g., baseband frames 678, 778), digital IF packets (e.g., digital IF packets 671, 771) containing digital IF waveforms or composite digital IF waveforms, among other possibilities.

At step 810, a new pod is added to the satellite service chain. The new pod may be deployed on the first compute node or the second compute node based on a configuration file for the new pod. For example, the configuration file for the new pod may specify the compute node on which the new pod is to be deployed. The first configuration file and/or the second configuration file may be modified to add the new pod to the satellite service chain. For example, the first CNI plugin may modify the first configuration file to set at least one of the previous pod for the first pod or the subsequent pod for the first pod to the new pod, or the second CNI plugin may modify the second configuration file to set at least one of the previous pod for the second pod or the subsequent pod for the second pod to the new pod. The first CNI plugin and/or the second CNI plugin may then connect the new pod to the first interface or the second interface to enable communication to/from the new pod. Upon connecting the new pod to the first or second interfaces, the new pod may communicate data (including PDUs, baseband frames, and/or digital IF packets) with the first and second pods via the connected interface.

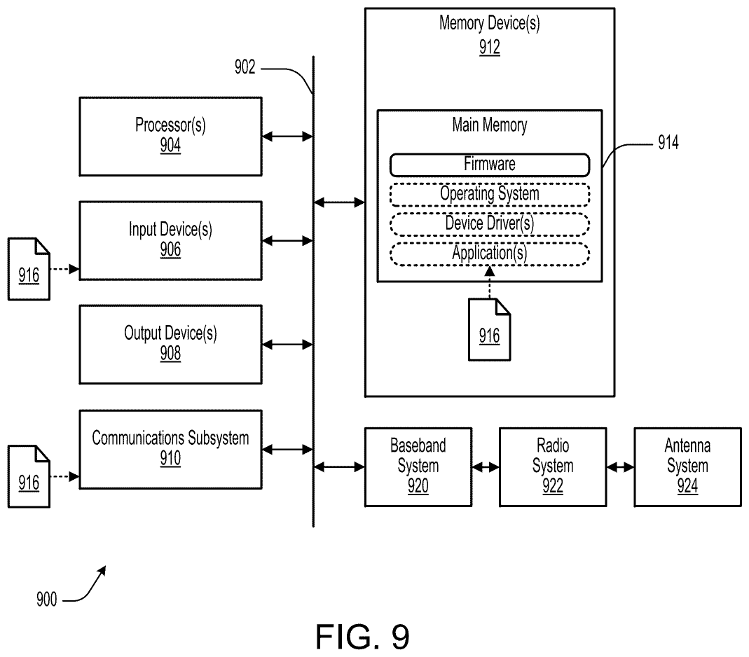

FIG. 9 illustrates an example computer system 900 comprising various hardware elements, in accordance with some embodiments of the present disclosure. Computer system 900 may be incorporated into or integrated with devices described herein and/or may be configured to perform some or all of the steps of the methods provided by various embodiments. It should be noted that FIG. 9 is meant only to provide a generalized illustration of various components, any or all of which may be utilized as appropriate. FIG. 9, therefore, broadly illustrates how individual system elements may be implemented in a relatively separated or relatively more integrated manner.

In the illustrated example, computer system 900 includes a communication medium 902, one or more processor(s) 904, one or more input device(s) 906, one or more output device(s) 908, a communications subsystem 910, one or more memory device(s) 912, a baseband system 920, a radio system 922, and an antenna system 924. Computer system 900 may be implemented using various hardware implementations and embedded system technologies. For example, one or more elements of computer system 900 may be implemented within an integrated circuit (IC), an application-specific integrated circuit (ASIC), an application-specific standard product (ASSP), a field-programmable gate array (FPGA), such as those commercially available by XILINX®, INTEL®, or LATTICE SEMICONDUCTOR®, a system-on-a-chip (SoC), a microcontroller, a printed circuit board (PCB), and/or a hybrid device, such as an SoC FPGA, among other possibilities.

The various hardware elements of computer system 900 may be communicatively coupled via communication medium 902. While communication medium 902 is illustrated as a single connection for purposes of clarity, it should be understood that communication medium 902 may include various numbers and types of communication media for transferring data between hardware elements. For example, communication medium 902 may include one or more wires (e.g., conductive traces, paths, or leads on a PCB or integrated circuit (IC), microstrips, striplines, coaxial cables), one or more optical waveguides (e.g., optical fibers, strip waveguides), and/or one or more wireless connections or links (e.g., infrared wireless communication, radio communication, microwave wireless communication), among other possibilities.

In some embodiments, communication medium 902 may include one or more buses that connect the pins of the hardware elements of computer system 900. For example, communication medium 902 may include a bus that connects processor(s) 904 with main memory 914, referred to as a system bus, and a bus that connects main memory 914 with input device(s) 906 or output device(s) 908, referred to as an expansion bus. The system bus may itself consist of several buses, including an address bus, a data bus, and a control bus. The address bus may carry a memory address from processor(s) 904 to the address bus circuitry associated with main memory 914 in order for the data bus to access and carry the data contained at the memory address back to processor(s) 904. The control bus may carry commands from processor(s) 904 and return status signals from main memory 914. Each bus may include multiple wires for carrying multiple bits of information and each bus may support serial or parallel transmission of data.

Processor(s) 904 may include one or more central processing units (CPUs), graphics processing units (GPUs), neural network processors or accelerators, digital signal processors (DSPs), and/or other general-purpose or special-purpose processors capable of executing instructions. A CPU may take the form of a microprocessor, which may be fabricated on a single IC chip of metal-oxide-semiconductor field-effect transistor (MOSFET) construction. Processor(s) 904 may include one or more multi-core processors, in which each core may read and execute program instructions concurrently with the other cores, increasing speed for programs that support multithreading.

Input device(s) 906 may include one or more of various user input devices such as a mouse, a keyboard, a microphone, as well as various sensor input devices, such as an image capture device, a temperature sensor (e.g., thermometer, thermocouple, thermistor), a pressure sensor (e.g., barometer, tactile sensor), a movement sensor (e.g., accelerometer, gyroscope, tilt sensor), a light sensor (e.g., photodiode, photodetector, charge-coupled device), and/or the like. Input device(s) 906 may also include devices for reading and/or receiving removable storage devices or other removable media. Such removable media may include optical discs (e.g., Blu-ray discs, DVDs, CDs), memory cards (e.g., CompactFlash card, Secure Digital (SD) card, Memory Stick), floppy disks, Universal Serial Bus (USB) flash drives, external hard disk drives (HDDs) or solid-state drives (SSDs), and/or the like.

Output device(s) 908 may include one or more of various devices that convert information into human-readable form, such as without limitation a display device, a speaker, a printer, a haptic or tactile device, and/or the like. Output device(s) 908 may also include devices for writing to removable storage devices or other removable media, such as those described in reference to input device(s) 906. Output device(s) 908 may also include various actuators for causing physical movement of one or more components. Such actuators may be hydraulic, pneumatic, electric, and may be controlled using control signals generated by computer system 900.

Communications subsystem 910 may include hardware components for connecting computer system 900 to systems or devices that are located external to computer system 900, such as over a computer network. In various embodiments, communications subsystem 910 may include a wired communication device coupled to one or more input/output ports (e.g., a universal asynchronous receiver-transmitter (UART)), an optical communication device (e.g., an optical modem), an infrared communication device, a radio communication device (e.g., a wireless network interface controller, a BLUETOOTH® device, an IEEE 802.11 device, a Wi-Fi device, a Wi-Max device, a cellular device), among other possibilities.

Memory device(s) 912 may include the various data storage devices of computer system 900. For example, memory device(s) 912 may include various types of computer memory with various response times and capacities, from faster response times and lower capacity memory, such as processor registers and caches (e.g., L0, L1, L2), to medium response time and medium capacity memory, such as random-access memory (RAM), to lower response times and lower capacity memory, such as solid-state drives and hard drive disks. While processor(s) 904 and memory device(s) 912 are illustrated as being separate elements, it should be understood that processor(s) 904 may include varying levels of on-processor memory, such as processor registers and caches that may be utilized by a single processor or shared between multiple processors.

Memory device(s) 912 may include main memory 914, which may be directly accessible by processor(s) 904 via the address and data buses of communication medium 902. For example, processor(s) 904 may continuously read and execute instructions stored in main memory 914. As such, various software elements may be loaded into main memory 914 to be read and executed by processor(s) 904 as illustrated in FIG. 9. Typically, main memory 914 is volatile memory, which loses all data when power is turned off and accordingly needs power to preserve stored data. Main memory 914 may further include a small portion of non-volatile memory containing software (e.g., firmware, such as BIOS) that is used for reading other software stored in memory device(s) 912 into main memory 914. In some embodiments, the volatile memory of main memory 914 is implemented as RAM, such as dynamic random-access memory (DRAM), and the non-volatile memory of main memory 914 is implemented as read-only memory (ROM), such as flash memory, erasable programmable read-only memory (EPROM), or electrically erasable programmable read-only memory (EEPROM).

Computer system 900 may include software elements, shown as being currently located within main memory 914, which may include an operating system, device driver(s), firmware, compilers, and/or other code, such as one or more application programs, which may include computer programs provided by various embodiments of the present disclosure. Merely by way of example, one or more steps described with respect to any methods discussed above, may be implemented as instructions 916, which are executable by computer system 900. In one example, such instructions 916 may be received by computer system 900 using communications subsystem 910 (e.g., via a wireless or wired signal that carries instructions 916), carried by communication medium 902 to memory device(s) 912, stored within memory device(s) 912, read into main memory 914, and executed by processor(s) 904 to perform one or more steps of the described methods. In another example, instructions 916 may be received by computer system 900 using input device(s) 906 (e.g., via a reader for removable media), carried by communication medium 902 to memory device(s) 912, stored within memory device(s) 912, read into main memory 914, and executed by processor(s) 904 to perform one or more steps of the described methods.

Computer system 900 may include optional wireless communication components that facilitate wireless communication over a voice network and/or a data network. The wireless communication components comprise an antenna system 924, a radio system 922, and a baseband system 920. In computer system 900, RF signals are transmitted and received over the air by antenna system 924 under the management of radio system 922. In an embodiment, antenna system 924 may comprise one or more antennae and one or more multiplexors (not shown) that perform a switching function to provide antenna system 924 with transmit and receive signal paths. In the reception path, received RF signals can be coupled from a multiplexor to a low noise amplifier (not shown) that amplifies the received RF signal and sends the amplified signal to radio system 922. In an alternative embodiment, radio system 922 may comprise one or more radios that are configured to communicate over various frequencies. In an embodiment, radio system 922 may combine a demodulator (not shown) and modulator (not shown) in one integrated circuit (IC). The demodulator and modulator can also be separate components. In the incoming path, the demodulator strips away the RF carrier signal leaving a baseband receive audio signal, which is sent from radio system 922 to baseband system 920.

In some embodiments of the present disclosure, instructions 916 are stored on a computer-readable storage medium (or simply computer-readable medium). Such a computer-readable medium may be non-transitory and may therefore be referred to as a non-transitory computer-readable medium. In some cases, the non-transitory computer-readable medium may be incorporated within computer system 900. For example, the non-transitory computer-readable medium may be one of memory device(s) 912 (as shown in FIG. 9). In some cases, the non-transitory computer-readable medium may be separate from computer system 900. In one example, the non-transitory computer-readable medium may be a removable medium provided to input device(s) 906 (as shown in FIG. 9), such as those described in reference to input device(s) 906, with instructions 916 being read into computer system 900 by input device(s) 906. In another example, the non-transitory computer-readable medium may be a component of a remote electronic device, such as a mobile phone, that may wirelessly transmit a data signal that carries instructions 916 to computer system 900 and that is received by communications subsystem 910 (as shown in FIG. 9).

Instructions 916 may take any suitable form to be read and/or executed by computer system 900. For example, instructions 916 may be source code (written in a human-readable programming language such as Java, C, C++, C #, Python), object code, assembly language, machine code, microcode, executable code, and/or the like. In one example, instructions 916 are provided to computer system 900 in the form of source code, and a compiler is used to translate instructions 916 from source code to machine code, which may then be read into main memory 914 for execution by processor(s) 904. As another example, instructions 916 are provided to computer system 900 in the form of an executable file with machine code that may immediately be read into main memory 914 for execution by processor(s) 904. In various examples, instructions 916 may be provided to computer system 900 in encrypted or unencrypted form, compressed or uncompressed form, as an installation package or an initialization for a broader software deployment, among other possibilities.

In one aspect of the present disclosure, a system (e.g., computer system 900) is provided to perform methods in accordance with various embodiments of the present disclosure. For example, some embodiments may include a system comprising one or more processors (e.g., processor(s) 904) that are communicatively coupled to a non-transitory computer-readable medium (e.g., memory device(s) 912 or main memory 914). The non-transitory computer-readable medium may have instructions (e.g., instructions 916) stored therein that, when executed by the one or more processors, cause the one or more processors to perform the methods described in the various embodiments.

In another aspect of the present disclosure, a computer-program product that includes instructions (e.g., instructions 916) is provided to perform methods in accordance with various embodiments of the present disclosure. The computer-program product may be tangibly embodied in a non-transitory computer-readable medium (e.g., memory device(s) 912 or main memory 914). The instructions may be configured to cause one or more processors (e.g., processor(s) 904) to perform the methods described in the various embodiments.

In another aspect of the present disclosure, a non-transitory computer-readable medium (e.g., memory device(s) 912 or main memory 914) is provided. The non-transitory computer-readable medium may have instructions (e.g., instructions 916) stored therein that, when executed by one or more processors (e.g., processor(s) 904), cause the one or more processors to perform the methods described in the various embodiments.

The methods, systems, and devices discussed above are examples. Various configurations may omit, substitute, or add various procedures or components as appropriate. For instance, in alternative configurations, the methods may be performed in an order different from that described, and/or various stages may be added, omitted, and/or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Specific details are given in the description to provide a thorough understanding of exemplary configurations including implementations. However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide those skilled in the art with an enabling description for implementing described techniques. Various changes may be made in the function and arrangement of elements without departing from the spirit or scope of the disclosure.

Having described several example configurations, various modifications, alternative constructions, and equivalents may be used without departing from the spirit of the disclosure. For example, the above elements may be components of a larger system, wherein other rules may take precedence over or otherwise modify the application of the technology. Also, a number of steps may be undertaken before, during, or after the above elements are considered. Accordingly, the above description does not bind the scope of the claims.

As used herein and in the appended claims, the singular forms “a”, “an”, and “the” include plural references unless the context clearly dictates otherwise. Thus, for example, reference to “a user” includes reference to one or more of such users, and reference to “a processor” includes reference to one or more processors and equivalents thereof known to those skilled in the art, and so forth.

Also, the words “comprise,” “comprising,” “contains,” “containing,” “include,” “including,” and “includes,” when used in this specification and in the following claims, are intended to specify the presence of stated features, integers, components, or steps, but they do not preclude the presence or addition of one or more other features, integers, components, steps, acts, or groups.

It is also understood that the examples and embodiments described herein are for illustrative purposes only and that various modifications or changes in light thereof will be suggested to persons skilled in the art and are to be included within the spirit and purview of this application and scope of the appended claims.

What is claimed is:

1. A method of forming a satellite service chain at a compute infrastructure having a set of compute nodes, the method comprising:
deploying a first pod on a first compute node of the compute infrastructure based on a first configuration file, the first pod implementing a first virtual network function (VNF), wherein the first configuration file specifies a previous pod and a subsequent pod for the first pod in the satellite service chain;
deploying a second pod on a second compute node of the compute infrastructure based on a second configuration file, the second pod implementing a second VNF, wherein the second configuration file specifies a previous pod and a subsequent pod for the second pod in the satellite service chain, wherein the subsequent pod for the first pod is set to the second pod, and wherein the previous pod for the second pod is set to the first pod;
running a first container network interface (CNI) plugin on the first compute node, wherein the first CNI plugin is configured to connect the first pod to a first interface of a set of interfaces of the first compute node in accordance with the first configuration file; and
running a second CNI plugin on the second compute node, wherein the second CNI plugin is configured to connect the second pod to a second interface of a set of interfaces of the second compute node in accordance with the second configuration file, wherein the satellite service chain is formed by connecting the first and second pods to the first and second interfaces in accordance with the first and second configuration files.

2. The method of claim 1, further comprising:
deploying a third pod on the first compute node based on a third configuration file, the third pod implementing a third VNF, wherein the third configuration file specifies a previous pod and a subsequent pod for the third pod in the satellite service chain, wherein the subsequent pod for the third pod is set to the first pod, and wherein the previous pod for the first pod is set to the third pod;
wherein the first CNI plugin is configured to connect the third pod to the first interface of the set of interfaces of the first compute node in accordance with the third configuration file.

3. The method of claim 2, further comprising:
deploying a fourth pod on the second compute node based on a fourth configuration file, the fourth pod implementing a fourth VNF, wherein the fourth configuration file specifies a previous pod and a subsequent pod for the fourth pod in the satellite service chain, wherein the subsequent pod for the second pod is set to the fourth pod, and wherein the previous pod for the fourth pod is set to the second pod;
wherein the second CNI plugin is configured to connect the fourth pod to the second interface of the set of interfaces of the second compute node in accordance with the fourth configuration file.

4. The method of claim 1, further comprising:
adding a new pod to the satellite service chain by:
deploying the new pod on the first compute node or the second compute node based on a configuration file for the new pod; and
modifying the first configuration file using the first CNI plugin or the second configuration file using the second CNI plugin to set at least one of the previous pod for the first pod, the subsequent pod for the first pod, the previous pod for the second pod, the subsequent pod for the second pod to the new pod.

5. The method of claim 1, wherein the first CNI plugin is further configured to assign a first internet protocol (IP) address to the first pod, and wherein the second CNI plugin is further configured to assign a second IP address to the second pod.

6. The method of claim 1, wherein each of the first VNF and the second VNF is a virtual receiver, a virtual transmitter, or a combiner.

7. The method of claim 1, wherein the compute infrastructure is a cluster consisting of a set of servers including the set of compute nodes.

8. A non-transitory computer-readable medium comprising instructions that, when executed by one or more processors, cause the one or more processors to perform operations for forming a satellite service chain at a compute infrastructure having a set of compute nodes, the operations comprising:
deploying a first pod on a first compute node of the compute infrastructure based on a first configuration file, the first pod implementing a first virtual network function (VNF), wherein the first configuration file specifies a previous pod and a subsequent pod for the first pod in the satellite service chain;
deploying a second pod on a second compute node of the compute infrastructure based on a second configuration file, the second pod implementing a second VNF, wherein the second configuration file specifies a previous pod and a subsequent pod for the second pod in the satellite service chain, wherein the subsequent pod for the first pod is set to the second pod, and wherein the previous pod for the second pod is set to the first pod;
running a first container network interface (CNI) plugin on the first compute node, wherein the first CNI plugin is configured to connect the first pod to a first interface of a set of interfaces of the first compute node in accordance with the first configuration file; and
running a second CNI plugin on the second compute node, wherein the second CNI plugin is configured to connect the second pod to a second interface of a set of interfaces of the second compute node in accordance with the second configuration file, wherein the satellite service chain is formed by connecting the first and second pods to the first and second interfaces in accordance with the first and second configuration files.

9. The non-transitory computer-readable medium of claim 8, wherein the operations further comprise:
deploying a third pod on the first compute node based on a third configuration file, the third pod implementing a third VNF, wherein the third configuration file specifies a previous pod and a subsequent pod for the third pod in the satellite service chain, wherein the subsequent pod for the third pod is set to the first pod, and wherein the previous pod for the first pod is set to the third pod;
wherein the first CNI plugin is configured to connect the third pod to the first interface of the set of interfaces of the first compute node in accordance with the third configuration file.

10. The non-transitory computer-readable medium of claim 9, wherein the operations further comprise:
deploying a fourth pod on the second compute node based on a fourth configuration file, the fourth pod implementing a fourth VNF, wherein the fourth configuration file specifies a previous pod and a subsequent pod for the fourth pod in the satellite service chain, wherein the subsequent pod for the second pod is set to the fourth pod, and wherein the previous pod for the fourth pod is set to the second pod;
wherein the second CNI plugin is configured to connect the fourth pod to the second interface of the set of interfaces of the second compute node in accordance with the fourth configuration file.

11. The non-transitory computer-readable medium of claim 8, wherein the operations further comprise:
adding a new pod to the satellite service chain by:
deploying the new pod on the first compute node or the second compute node based on a configuration file for the new pod; and
modifying the first configuration file using the first CNI plugin or the second configuration file using the second CNI plugin to set at least one of the previous pod for the first pod, the subsequent pod for the first pod, the previous pod for the second pod, the subsequent pod for the second pod to the new pod.

12. The non-transitory computer-readable medium of claim 8, wherein the first CNI plugin is further configured to assign a first internet protocol (IP) address to the first pod, and wherein the second CNI plugin is further configured to assign a second IP address to the second pod.

13. The non-transitory computer-readable medium of claim 8, wherein each of the first VNF and the second VNF is a virtual receiver, a virtual transmitter, or a combiner.

14. The non-transitory computer-readable medium of claim 8, wherein the compute infrastructure is a cluster consisting of a set of servers including the set of compute nodes.

15. A system comprising:
one or more processors; and
a computer-readable medium comprising instructions that, when executed by the one or more processors, cause the one or more processors to perform operations for forming a satellite service chain at a compute infrastructure having a set of compute nodes, the operations comprising:
deploying a first pod on a first compute node of the compute infrastructure based on a first configuration file, the first pod implementing a first virtual network function (VNF), wherein the first configuration file specifies a previous pod and a subsequent pod for the first pod in the satellite service chain;
deploying a second pod on a second compute node of the compute infrastructure based on a second configuration file, the second pod implementing a second VNF, wherein the second configuration file specifies a previous pod and a subsequent pod for the second pod in the satellite service chain, wherein the subsequent pod for the first pod is set to the second pod, and wherein the previous pod for the second pod is set to the first pod;
running a first container network interface (CNI) plugin on the first compute node, wherein the first CNI plugin is configured to connect the first pod to a first interface of a set of interfaces of the first compute node in accordance with the first configuration file; and
running a second CNI plugin on the second compute node, wherein the second CNI plugin is configured to connect the second pod to a second interface of a set of interfaces of the second compute node in accordance with the second configuration file, wherein the satellite service chain is formed by connecting the first and second pods to the first and second interfaces in accordance with the first and second configuration files.

16. The system of claim 15, wherein the operations further comprise:
deploying a third pod on the first compute node based on a third configuration file, the third pod implementing a third VNF, wherein the third configuration file specifies a previous pod and a subsequent pod for the third pod in the satellite service chain, wherein the subsequent pod for the third pod is set to the first pod, and wherein the previous pod for the first pod is set to the third pod;
wherein the first CNI plugin is configured to connect the third pod to the first interface of the set of interfaces of the first compute node in accordance with the third configuration file.

17. The system of claim 16, wherein the operations further comprise:
deploying a fourth pod on the second compute node based on a fourth configuration file, the fourth pod implementing a fourth VNF, wherein the fourth configuration file specifies a previous pod and a subsequent pod for the fourth pod in the satellite service chain, wherein the subsequent pod for the second pod is set to the fourth pod, and wherein the previous pod for the fourth pod is set to the second pod;
wherein the second CNI plugin is configured to connect the fourth pod to the second interface of the set of interfaces of the second compute node in accordance with the fourth configuration file.

18. The system of claim 15, wherein the operations further comprise:
adding a new pod to the satellite service chain by:
deploying the new pod on the first compute node or the second compute node based on a configuration file for the new pod; and
modifying the first configuration file using the first CNI plugin or the second configuration file using the second CNI plugin to set at least one of the previous pod for the first pod, the subsequent pod for the first pod, the previous pod for the second pod, the subsequent pod for the second pod to the new pod.

19. The system of claim 15, wherein the first CNI plugin is further configured to assign a first internet protocol (IP) address to the first pod, and wherein the second CNI plugin is further configured to assign a second IP address to the second pod.

20. The system of claim 15, wherein each of the first VNF and the second VNF is a virtual receiver, a virtual transmitter, or a combiner.
